(19) United States
(12) Patent Application Publication
(10) Pub. No.: US 2009/0019413 A1
(43) Pub. Date: Jan. 15, 2009

(54) System and method for automatic layout of integrated circuit

(75) Inventor: Naohiro Kobayashi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/216,905

(22) Filed: Jul. 11, 2008

(30) Foreign Application Priority Data
Jul. 13, 2007 (JP) 2007-184264

(51) Int. Cl. G06F 17/50

(52) U.S. Cl. 716/9

(57) ABSTRACT

An automatic layout apparatus is provided with: a storage device storing a cell library containing therein cell library data; and a layout tool obtaining from the cell library the cell library data associated with cells to be placed as described in a netlist to perform automatic placement of the cells to be placed. The obtained cell library data include layout coordinates of diffusion layers within the cells to be placed. The layout tool determines positions of the cells to be placed, referring to the layout coordinates of the diffusion layers.

This application claims the benefit of priority based on Japanese Patent Application No. 2007-184264, filed on Jul. 13, 2007, the disclosure of which is incorporated herein by reference.

### BACKGROUND OF THE INVENTION

1. Field of the Invention

The present invention relates to a system and method for automatic layout of semiconductor integrated circuits (ICs), more particularly, to a technique for automatic layout of cell-based ICs.

2. Description of the Related Art

Cell-based ICs (Integrated Circuit) are preferably used in various LSIs, such as ASICs (Application Specific Integrated Circuits), microprocessors required to achieve large scale integration and high performance, and ASSPs (Application Specific Standard Products). The cell-based IC is designed by combining ready-made cells to form a user-specific circuit; the cells are prepared in a cell library provided by a semiconductor manufacturer. The cell library prepares various kinds of cells having various sizes, including primitive cells incorporating basic circuits, and macro cells incorporating macro circuits, such as CPUs and memories. The cell-based IC design has advantages of reduced design time and cost, since circuit design of the target chip is achieved through placement of ready-made cells and routing therebetween by using a placement and routing tool. In addition, the cell-based IC design advantageously make it easy to design a system LSI, which allows incorporating the layout of a CPU and the like as a macro cell without change.

FIG. 1 is a plan view showing a layout of a semiconductor chip 100 in which cells are arranged by a conventional technique. In one exemplary arrangement, cells 101 to 104 are arrayed in a row in the direction perpendicular to gate electrodes (referred to as the X-direction, hereinafter), and cells 201 to 203 are arrayed in another row in the X-direction.

There is a case where distances between diffusion layers in two adjacent cells arrayed in the X-direction (the distance between a diffusion layer 111 and a diffusion layer 112, for example) are not uniform, because the arrangement of the cells are usually determined in light of the reduction of the area size and the easiness of interconnection routing. Distances between diffusion layers of adjacent cells in the same row may vary. In FIG. 1, the distance DS11 is different from the distance DS12, where the distance DS11 is the distance between the diffusion layer 111 of the cell 101 and the diffusion layer 112 of the cell 102, and the distance DS12 is the distance between the diffusion layer 111 of the cell 102 and the diffusion layer 112 of the cell 103. Similarly, the distance DS14 is different from the distance DS15, where the distance DS14 is the distance between the diffusion layer 111 of the cell 201 and the diffusion layer 112 of the cell 202, and the distance DS15 is the distance between the diffusion layer 111 of the cell 202 and the diffusion layer 112 of the cell 203.

As is known in the art, the stress (internal stress) applied to the channel region within a MOS transistor from an element isolation region, such as an STI (shallow trench isolation) region, causes variations in drive characteristics of the MOS transistor. Referring to FIG. 1, for example, the stresses exerted to the channel regions of the respective MOS transistors vary depending on the cells, due to the variations in the distances between the diffusion layers of adjacent cells.

More specifically, the stress applied to the MOS transistor of the cell 101 and the stress applied to the MOS transistor of the cell 102 are different from each other, since the distance DS11 between the diffusion layer 111 of the cell 101 and the diffusion layer 112 of the cell 102 is different from the distance DS12 between the diffusion layer 111 of the dell 102 and the diffusion layer 112 of the cell 103. On the other hand, the stresses of the same magnitude are exerted to the diffusion layer 111 of the cell 102 and the diffusion layer 111 of the cell 103, when the distance DS12 is equal to the distance DS13 between the diffusion layer 111 of the cell 103 and the diffusion layer 112 of the cell 104. Moreover, the stress applied to the diffusion layer 112 of the cell 102 and the stress applied to the diffusion layer 112 of the cell 103 are different from each other. Therefore, the drive characteristics of the MOS transistors within the cells 101 to 104 exhibit variations, and this results in degradation of the product performance of the semiconductor chip 100.

In recent years, the characteristic variation of the MOS transistor resulting from the variation in the stress as described above is regarded as an issue in connection with the progress in the fine processing technology of the semiconductor circuit. Therefore, a technique of equalizing the stress exerted to the diffusion layer is strongly desired.

Contrary to this, a technique of achieving a desired performance through positively using the stress from the isolation region is known in the art, as is disclosed in Japanese Laid Open Patent Application No. JP-P2006-190727A, for example. Moreover, a technique of equalizing the stress applied to the channel region from the trench isolation region in the channel width direction (the gate width direction) is known in the art, as disclosed in, for example, Japanese Laid Open Patent Application No. JP-P2004-241529A, which may be referred to as the '529 application, hereinafter.

These techniques, however, do not reduce the variation in the distance between the diffusion layers of the different cells within a cell-based IC. It should be especially noted that, although effectively reducing the variation in the stress in the channel width direction (the gate width direction), the technique disclosed in the '529 application does not reduce the variation in the distance between the diffusion layers in the channel length direction, in other words, the gate length direction.

Moreover, conventional automatic layout techniques disregard diffusion layers within cells, positions of gates, and so on, to enhance the processing speed, although referring to outline data of cell frames and positions of power supply terminals and signal terminals. It should be noted that, in general, the distance from the edge of the diffusion layer to the edge of the cell in the gate length direction is not unified in cells used in the conventional automatic layout technique in order to optimize individual cell layouts. Therefore, conventional automatic layout techniques based on such cells can not achieve automatic layout based on coordinates of diffusion layers in the gate length direction. Conventional automatic layout techniques do not sufficiently suppress variations in the MOS transistor characteristics resulting especially from the variations in the stress exerted to the diffusion layer in the gate width direction.

### SUMMARY

In an aspect of the present invention, an automatic layout apparatus is provided with: a storage device storing a cell library containing therein cell library data; and a layout tool obtaining from the cell library the cell library data associated with cells to be placed as described in a netlist to perform automatic placement of the cells to be placed. The obtained cell library data include layout coordinates of diffusion layers within the cells to be placed. The layout tool determines positions of the cells to be placed, referring to the layout coordinates of the diffusion layers.

The automatic layout apparatus thus constructed provides optimal adjustment of the distance between diffusion layers for adjacent cells, and thereby effectively reduces the variations in the stress caused by element isolation regions. This effectively reduces the variations in the drive characteristics of transistors integrated within cells.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a plan view showing cell arrangement and spacings of diffusion layers between adjacent cells within a cell-based IC chip in accordance with a conventional technique;

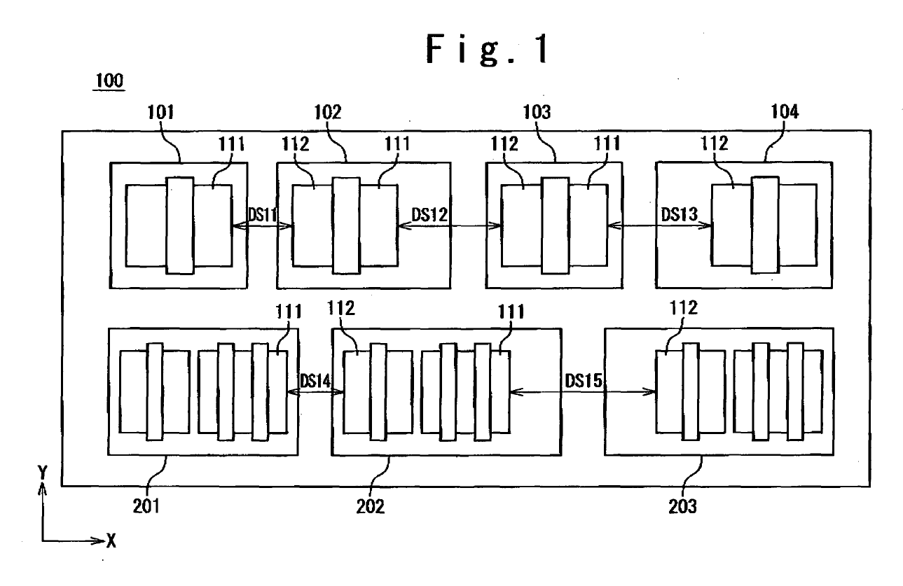

FIG. 2 is a block diagram showing an exemplary configuration of an automatic layout apparatus in one embodiment of the present invention;

FIG. 3 is a block diagram showing an exemplary configuration and operation of the automatic layout apparatus shown in FIG. 2;

FIG. 4 shows data structures of library data and corrected library data in one embodiment of the present invention;

FIG. 5 shows diagrams showing layouts corresponding to cell data included in the library data and the corrected library data in one embodiment of the present invention;

FIG. 6 is a plan view showing an exemplary configuration of a target cell-based IC chip in one embodiment of the present invention;

FIG. 7 is a diagram illustrating a method of calculating a distance between diffusion layers in two adjacent cells; and

FIG. 8 is a plan view showing cell arrangement spacings of diffusion layers between adjacent cells in one embodiment of the present invention.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes. In the following, a description will be given taking an automatic layout apparatus for designing cell-based ICs as one example.

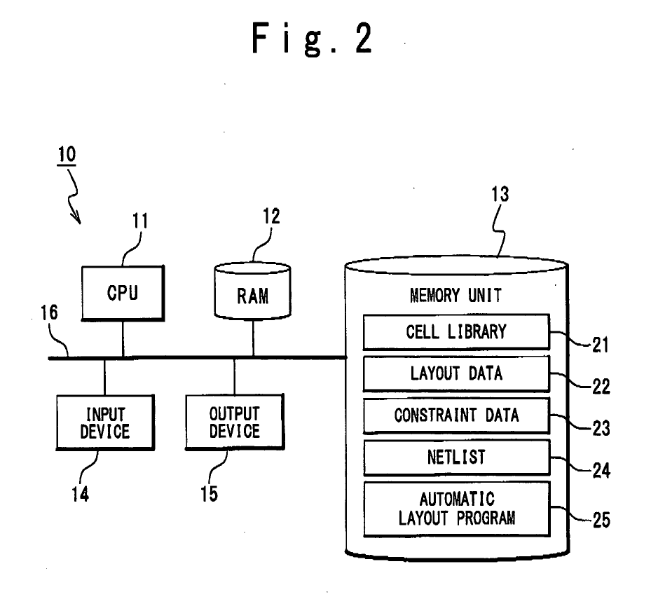

As shown in FIG. 2, an automatic layout apparatus 10 is provided with a CPU 11, a RAM 12, a storage device 13, an input device 14, and an output device 15, all of which are mutually connected through a bus 16. The storage device 13 is an external storage, such as a hard disk drive. The input device 14 provides various data for the CPU 11 and the storage device 13 in response to user operations. The input device 14 may include a keyboard, a mouse, or the like. The output device 15 visually outputs the layout result of the target cell-based IC to the user. The output device 15 may include a monitor and a printer.

The storage device 13, which is a sort of recording medium, stores therein a cell library 21, layout data 22, constraint data 23, a netlist 24, and an automatic layout program 25. The CPU 11 executes the automatic layout program 25 installed onto the storage device 13 in response to an input from the input device 14, to thereby perform generation or conversion of the cell library, and to perform placement and routing of the target cell-based IC. The RAM 12 temporarily stores various data and programs received from the storage device 13, and the CPU 11 performs various processing using the data stored in the RAM 12.

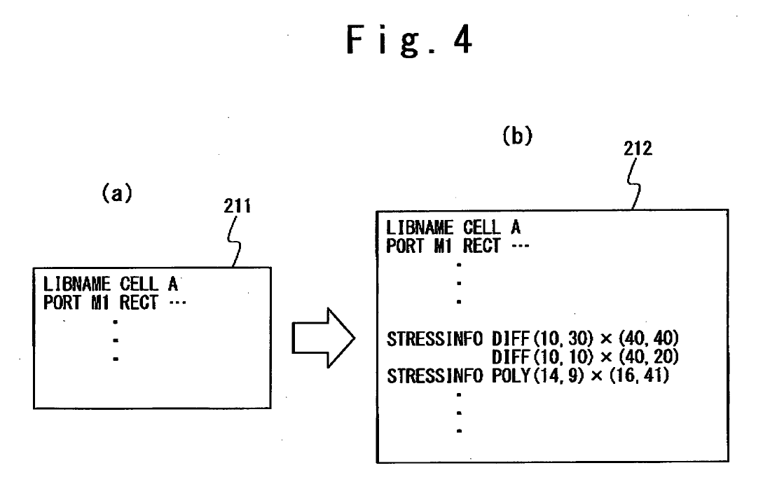

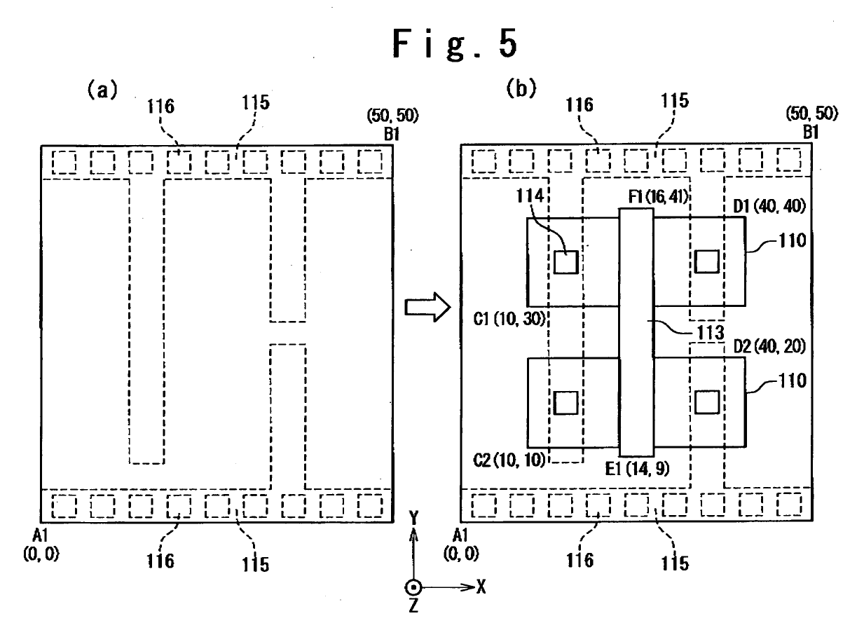

Referring to FIG. 2, the cell library 21 incorporates a set of data related to ready-made cells including macro cells. Registered in the cell library 21 are cells containing fundamental circuits, such as NAND gates and flip-flops, and macro cells containing large scale circuits, such as RAMs, ROMs, and CPU cores. The data stored in the cell library 21 include library data 211 and modified library data 212. The library data 211 indicates the layouts of the respective registered cells (and macro cells). It should be noted that the library data 211 do not describe coordinates of diffusion layers and gates within the respective cells. The modified library data 212 are what the library data 211 and coordinate data of the diffusion layers and gates within the respective cells are added together. The library data 211 and the modified library data 212 contain pin assignment data and cell frame data of the respective cells. The library data 211 and the modified library data 212 are both LEF (Library Exchange Format) data used for implementing placement and routing for the target cell-base IC. As shown in FIGS. 4 and 5, the library data 211 specify cell outer shapes of the respective cells, connection positions of external wirings, and the routing forbidden area, describing positions of interconnections 115 and terminals 116 within the cells. It should be noted that the library data 211 do not include data indicative of lower layer structures of the respective cells, such as layout coordinates of diffusion layers and polysilicon layers, which are positioned below interconnection layers. The modified library data 212 are LEF data incorporating the library data 211 and layout data indicative of lower layer structures within the respective cells. More specifically, as shown in FIGS. 4 and 5, the modified library data 212 includes data indicative of the layouts of diffusion layers and polysilicon layers within the respective cells in addition to data specifying positions of the interconnections 115 and the terminals 116 within the respective cells.

The layout data 22 are GDS format data that include diffusion layer layout data 221, polysilicon gate layout data 222, and other data indicative of sizes of cell boundaries (or cell frames), layouts of interconnections and via contacts, and so on. The diffusion layer layout data 221 include position coordinates of the diffusion layers within in the respective cells. The polysilicon gate layout data 222 include position coordinates of polysilicon gates (gate electrodes) within in the respective cells.

The constraint data 23 defines conditions for determining the distance between diffusion layers of two adjacent cells arranged in the row direction (the X-direction), when a layout tool (placement and routing tool) 252 performs cell placement for the target cell-based IC. The netlist 24 is a logical-circuit design result data which describes connections of cells (including macro cells) within the target cell-based IC.

The automatic layout program 25, which is installed on the automatic layout apparatus 10 to be executed by the CPU 11, includes a library generation tool 251 and a layout tool 252. The library generation tool 251 generates the modified library data 212 by the library data 211 using the layout data 22, which are indicative of the layouts of the cells. The layout tool 252 performs cell placement and routing for the target cell-based IC, on the basis of the modified library data 212 and the netlist 24, and outputs chip layout data 26 indicative of the layout of the target cell-based IC. The layout tool 252 performs this placement and routing so as to satisfy the design rules, such as the interconnection width, and cell spacing, and interconnection delay requirements, referring to the pin assignments and sizes of the cells registered in the modified library data 212. In this placement and routing, the layout tool 252 determines the distance between every two adjacent cells arrayed in the row direction (the X-direction) referring to the layouts of the diffusion layers and the polysilicon layers described in the modified library data 212, so as to satisfy the constraint conditions described in the constraint data 23.

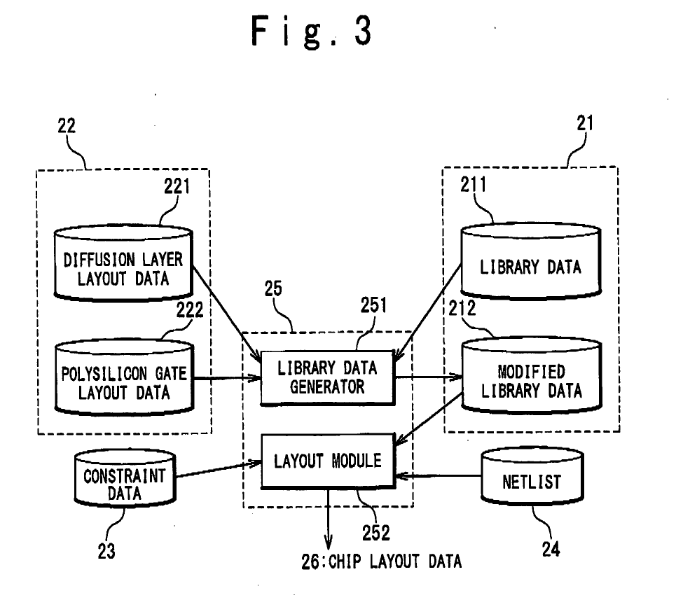

In the following, a detailed description is given of the automatic layout processing of the target cell-base IC by the automatic layout apparatus 10 referring to FIGS. 2 to 8. The layout processing includes two phases: generation of the modified library data 212, and cell placement and routing based on the modified library data 212.

### (Generation of Modified Library Data)

First, the library generation tool 251 refers to the cell library 21 for automatic layout. If the cell library 21 only includes the library data 211, the library generation tool 251 generates the modified library data 212 by modifying the library data 211. Specifically, the library generation tool 251 generates the modified library data 212 by adding portions of the layout data 22 associated with the cells registered in the library data 211 to the library data 211. In this case, the modified library data 212 are generated to incorporate the diffusion layer layout data 221 and the polysilicon gate layout data 222. The modified library data 212 may additionally incorporate layout data of contacts formed on the diffusion layers. The modified library data 212 may be prepared only for the cells to be integrated within the target cell-based IC. Instead, the modified library data 212 may be prepared for all the cells registered in the library data 212 of the cell library 21.

Referring to FIGS. 4 and 5, a detailed description is given of the generation of the modified library data 212. The section (a) in FIG. 4 shows exemplary contents of the library data 211 for a specific cell, and section (a) in FIG. 5 shows the layout of the specific cell, indicated by the library data 211. As shown in the sections (a) of FIGS. 4 and 5, the library data 211 do not include layout data of diffusions layers and polysilicon gates. It should be noted that layout data of diffusions layers and polysilicon gates are not necessary for performing commonly used placement and routing.

As shown in the section (b) of FIG. 4, the library generation tool 251 generates the modified library data 212 by adding layout data indicating shapes of the diffusion layers and the polysilicon gates (for example, the position coordinates) within the cells registered in the library data 211. In this embodiment, the shapes of the diffusion layers and the polysilicon gates are rectangular, and the position coordinates of respective corners of the diffusion layers and the polysilicon gates, which effectively specify the layouts of diffusion layers and the polysilicon gates, are added to the library data 211 to generate the modified library data 212.

A detailed description is then given of the layout data incorporated within the modified library data 212, referring to the section (b) of FIG. 5. In the example of FIG. 5, the cell of interest includes diffusion layers 110 and a polysilicon gate 113 that form a pair of MOS transistors. The library generation tool 251 generates the modified library data 212 by adding at least part of the layout data 22 used for calculating areas of the diffusion layers and the polysilicon gate that constitute the MOS transistors to the library data 211. It is preferable that the library generation tool 251 generates the modified library data 212 by adding only layout data of diffusion layers and polysilicon gate(s) of a MOS transistor(s) adjoining the boundary of each cell in the X-direction to the library data 211. This allows effectively reducing the data amount of the modified library data 212.

More specifically, the library generation tool 251 refers to portions of the diffusion layer layout data 221 associated with the cells registered in the library data 211 and extracts coordinate data of diffusion layer(s) adjacent to the boundary of each cell in the X-direction. As for the cell shown in the section (b) of FIG. 5, the library generation tool 251 extracts the coordinates A1 and B1 of the cell frame, the coordinates C1, D1, C2, and D2 of the diffusion layers 110. Moreover, the library generation tool 251 refers to portions of the polysilicon gate layout data 222 associated with the cell of interest, and extracts the coordinates E1 and F1 of the polysilicon gate 113 formed over the active region containing the diffusion layers 110. Although the shapes of the diffusion layers 110 and the polysilicon gate 113 are rectangular and therefore only the coordinates of the corners of the diffusion layers 110 and the polysilicon gate 113 are extracted in this example, it is preferable that the coordinates are extracted, not being limited to the above example, so that the shapes and areas of the diffusion layers and the polysilicon gates can be calculated. The library generation tool 251 generates the modified library data 212 by adding the extracted coordinates (layout data) to the library data 211. The library generation tool 251 may add layout data of contacts 114 formed on the diffusion layers 110 to the modified library data 212.

As thus described, the automatic layout apparatus 10 of this embodiment generates the modified library data 212 by adding layout data of diffusion layers and polysilicon gate layers formed below interconnection layers to the library data 211 of the cell library 21.

### (Cell Placement and Routing)

The layout tool 252 performs cell placement and routing for the target cell-based IC using the modified library data 212 of the cell library 21, which includes layout data of diffusion layers and other lower layers.

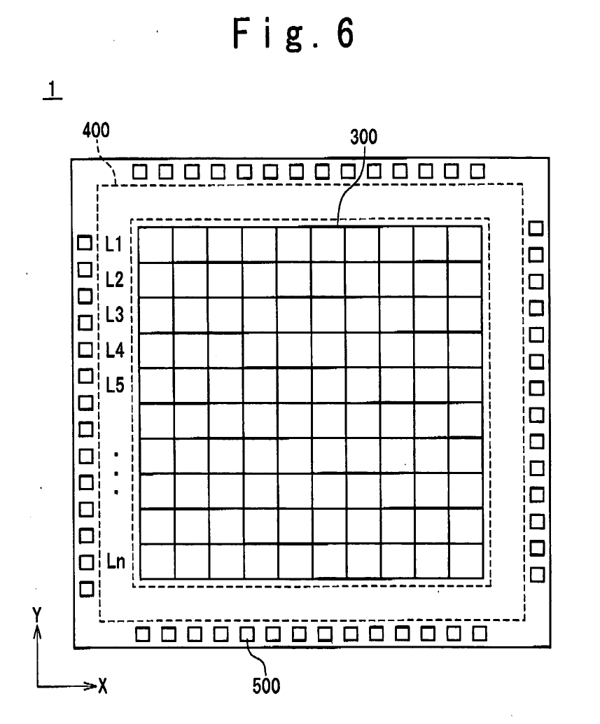

FIG. 6 is a diagram showing an exemplary configuration of the target cell-based IC, denoted by the numeral 1, for which cell placement and routing is performed by the layout tool 252. In cell placement for the cell-based IC 1, the layout tool 252 arranges cells in a cell arrangement area 300 on the basis of the modified library data 212. Moreover, the layout tool 252 also arranges input/output circuit cells in an input/output circuit area 400 and provides pads 500 to complete the cell placement of the cell-based IC 1. The layout tool 252 then performs routing in which interconnections are routed between cells on the basis of the netlist 24. The layout result of the cell-based IC 1 is stored in the storage device 13 as the chip layout data 26. The chip layout data 26 are visually outputted from the output device 15 to allow the designer to review the layout of the cell-based IC 1 referring to this data.

According to the inventors' study, the magnitude F of the stress exerted to a MOS transistor (strictly, to the channel region right below the gate) within a specific cell is significantly dependent on an area S of the diffusion layer adjoining the channel region and a distance DS of the diffusion layer from another diffusion layer of another cell adjacent to the specific cell. Here, the layout tool 252 determines distances between diffusion layers of every two adjacent cells so that stress exerted to MOS transistors of respective cells are equalized. This is based on the fact that the areas of the respective diffusion layers are already determined for every cell before the cell placement. For example, assuming that the magnitude of the stress exerted to a MOS transistor of a certain cell is F1 (S1, DS) and the magnitude of the stress exerted to another MOS transistor of another cell adjacent to the certain is F2 (S2, DS), the distance DS between the diffusion layers of the adjacent cells is determined so that F1 (S1, DS) is equal to F2 (S2, DS). Equalization of the magnitudes of the stresses among MOS transistors within all the cells effectively reduces variations in the characteristics of the MOS transistors.

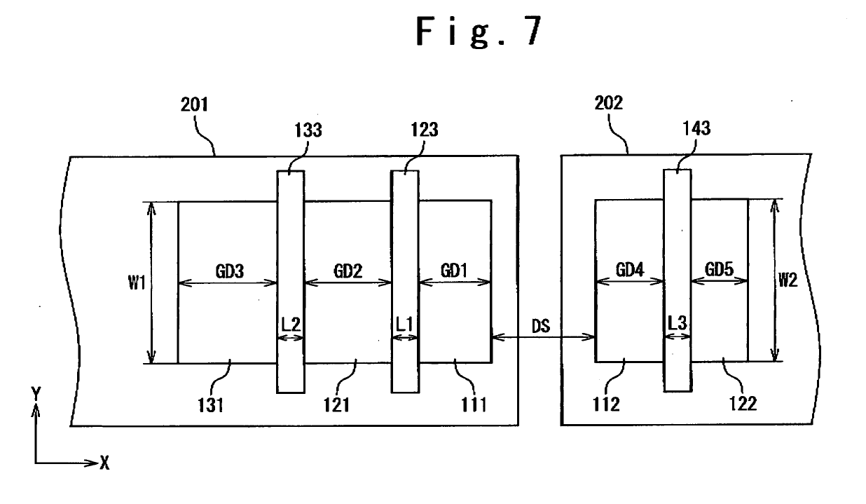

Referring to FIG. 7, a description will be given of cell arrangement, taking cells 201 and 202 that are to be arranged adjacently as an example. The cell 201 is provided with an active region over which gate electrodes 123, 133 are formed, and this active region incorporates three diffusion layers 111, 121, and 131. Here, the diffusion layers 111 and 121 are separated by the gate electrode 123 and the diffusion layers 121 and 131 are separated by the gate electrode 133. The widths of the diffusion layers 111, 121, and 131 (defined in the X-direction) are designated as GD1, GD2, and GD3, and the height of the diffusion layers 111, 121, and 131 (defined in the Y-direction) is designated as W1. The cell 202 is provided with an active region over which a gate electrode 143 is formed, and this active region incorporates diffusion layers 112 and 122. Here, the diffusion layers 112 and 122 are separated by the gate electrode 143. The widths of the diffusion layers 112 and 122 (defined in the X-direction) are designated as GD4, GD5, and the height of the diffusion layers 112 and 122 (defined in the Y-direction) is designated as W2.

When placing the two cells 201 and 202, which are to be arranged adjacent in the X-direction, the layout tool 252 calculates the areas of the respective diffusion layers 111, 121, 131 and the respective gate electrodes 123, 133 and 143 on the basis of the layout data included in the modified library data 212. Next, the stresses F1 and F2 exerted to the respective MOS transistors in the two cells 201 and 202 are calculated. The stresses F1 exerted to the channel regions of the MOS transistors formed within the cell 201 is mainly determined by the areas GD1×W1, GD2×W1, and GD3×W1, the areas L1×W1, L2×W1, and the distance DS between the diffusion layers 111 and 112, where GD1×W1, GD2×W1, and GD3×W1 are the areas of the diffusion layers 111, 121, and 131, respectively, and L1×W1 and L2×W1 are the areas of portions of the gate electrodes 123, 133 positioned right above the active region incorporating the diffusion layers 111, 121 and 131. Similarly, the stress F2 exerted to the channel region of the MOS transistor within the cell 202 is determined by the areas GD4×W2, GD5×W2, the area L3×W2, and the distance DS between the diffusion layers 111 and 112, where GD4×W2 and GD5×W2 are the areas of the diffusion layers 112 and 122, and L3×W2 is the area of the portion of the gate electrode 143 positioned right above the active region incorporating the diffusion layers 112, 122. It should be noted that L1, L2, and L3 are the gate lengths of the gate electrodes 123, 133, and 143, respectively, W1 is the gate width of the gate electrodes 123 and 133, and W2 is the gate width of the gate electrode 143.

The layout tool 252 determines the distance DS between the diffusion layers 111 and 112 so that the stresses exerted to other transistors and the stresses exerted to the transistors within the cells 201 and 202 are equal to one another. That is, the layout tool 252 determines the distance DS between the diffusion layers 111 112 so that F=F1 (GD1, GD2, GD3, W1, L1, L2, DS)=F2 (GD4, GD5, W2, L3, DS), where F is the stress exerted to MOS transistors within other cells. It should be noted that it may be impossible to satisfy the requirement of F1=F2 only by adjusting the distance DS, since the change in the distance DS between the diffusion layers 111 and 112 causes changes in both of the stresses F1 and F2. The requirement of F1=F2 may be satisfied by adjusting the distance between the diffusion layer 122 and a diffusion layer (not shown) adjacent to the right edge of the diffusion layer 122 to thereby adjust the stress F2 exerted to the MOS transistor within the cell 202. When the requirement of F1=F2 is not satisfied by such adjustment, a different kind of cells may be placed adjacent to the cells 201 and/or 202 to satisfy the requirement F1=F2. In addition or instead, a dummy diffusion layer may be disposed between the diffusion layers 111 and 112 so that distances between the dummy diffusion layer and the diffusion layers 111 and 112 are adjusted to satisfy the requirement of F1=F2. These adjustments are applied to all the cells, and the distances between the diffusion layers of all the cells are determined so that F=F1=F2=F3=F4= . . . =Fn is finally attained. Here, n is twice of the number of the diffusion layer spacing between the cells, and F3, F4, . . . , Fn denote stresses exerted to MOS transistors within all the cells other than the cells 201 and 202.

The stresses exerted to respective MOS transistors are not only dependent on lengths and widths of the diffusion layers, gate lengths, gate widths, and distances between diffusion layers, but also on the manufacturing process. Therefore, a formula for calculating actual stresses is desirably defined depending on a manufacturing process. One approach for obtaining the formula for calculating the stresses exerted to MOS transistors for the target manufacturing process is to derive an experimental formula through actual measurements of MOS transistors. In one embodiment, the process for obtaining the formula for calculating the stresses begins with actually manufacturing MOS transistors with various lengths and widths of diffusion layers, various gate lengths, gate widths, and various distances between the diffusion layers. This is followed by actually measuring characteristics of the MOS transistors and then finding an experimental formula that fits well with measurement results through a commonly known fitting technique. The experimental formula thus found is incorporated to the automatic layout program 25 to calculate calculating the stress F of the respective MOS transistors.

In one embodiment, the parameters used to determine the stresses exerted to the MOS transistors may additionally include one or more parameters other than those described above. For example, the stresses F may be calculated in view of sizes of contacts, which may be one factor to determine shapes of diffusion layers. In another embodiment, in the case where the uniformity of the stress between the diffusion layers is allowed to be reduced, the stresses exerted to the respective MOS transistors may be determined independently of the areas of the gate electrodes and the areas of the diffusion layers other than the areas of the adjacent diffusion layers 111 and 112. The optimization of the distance DS dependent on the areas of the adjacent diffusion layers 111 and 112 but independent on the areas of other diffusion layers effectively reduces the amount of layout data to be described within the modified library data 212. Furthermore, the stresses exerted to the respective MOS transistors may be calculated only from distances between diffusion layers within every two adjacent cells with the areas of the diffusion layers 111 and 112 neglected.

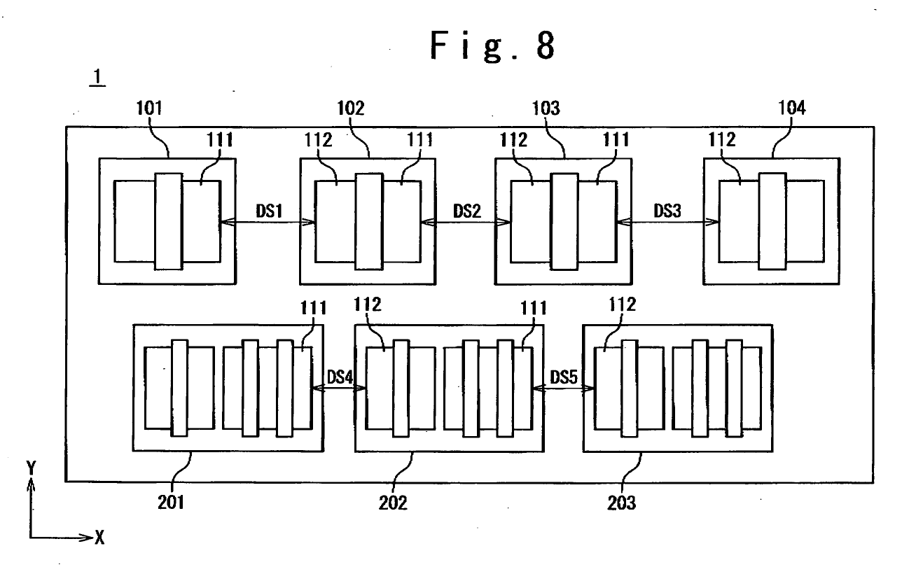

Referring to FIG. 6, the layout tool 252 places a plurality of cells in respective rows L1 to Ln through the method as described above. FIG. 8 shows one exemplary arrangement of the cells within the cell-based IC 1. In the arrangement of the cell-based IC 1 shown in FIG. 8, a plurality of cells with the same layout are arranged in the same row. As described above, the distance DS between the diffusion layers 111 and 112 within every two adjacent cells is adjusted so that the stresses applied to the respective MOS transistors are equalized. In order to achieve this, the distances DS1 to DS3 between the diffusion layers 111 and 112 within adjacent two of the cells 101 to 104, which are positioned in the same row, are adjusted to be equal to one another, and the distances DS4 and DS5 between the diffusion layers 111 and 112 within adjacent two of the cells 201 to 203, which are positioned in the same row, are adjusted to be equal to each other. Such arrangement effectively equalizes the stresses exerted to the MOS transistors within the cells in the same row, and reduces the variations in the drive characteristics of the MOS transistors within the cells in the same row.

As described above, in the layout method of this embodiment, the cells are arranged within the cell-base IC 1 with the distance DS adjusted between the diffusion layers of adjacent cells. This allows equalizing the stresses exerted to the transistors of the cells. This equalization effectively suppresses the drive characteristic variation of the transistors.

It is apparent that the present invention is not limited to the above embodiments, but may be modified and changed without departing from the scope of the invention. For example, although the library generation tool 251 in the above-described embodiments generates the modified library data 212 by correcting the cell library for automatic layout (the library data 211) that is used as the input of the layout tool in the conventional technique, the generation of the modified library data 212 is not limited to this method. The library generation tool 251 may generate the modified library data 212 using the diffusion layer layout data 221 or the polysilicon gate layout data 222, without using the library data 211. Moreover, when the library data 212 including the coordinates of the diffusion layers or the gate are prepared in advance, the library generation tool 251 may perform the automatic layout using the library data 212, omitting the library generation 251. Still moreover, although the above-described embodiments are explained with the arrangement in which the cells with the same layout are arrayed in the same row, the cells with different layouts may exist in the same row. In a case where the cells with different layouts are arrayed in the same row, if the arrangement is periodical, the distance between the cells becomes uniform. Accordingly, the characteristic variation of the MOS transistor in the cell can be suppressed.

Furthermore, the automatic layout according to the present invention may be applied to all the circuits of one chip. Alternatively, the automatic layout according to the present invention may be applied as follows: among all the circuits of the one chip, circuits that are not stringent in the timing is specified as the object of application of the conventional automatic layout that does not consider the distance between the diffusion layers etc., so that the layout density is increased, whereas only circuits where restriction of the timing is especially stringent are specified as the object of the automatic layout of the present invention, so that the characteristic variations can be suppressed.

What is claimed is:

1. An automatic layout apparatus comprising:
a storage device storing a cell library containing therein cell library data; and
a layout tool obtaining from said cell library said cell library data associated with cells to be placed as described in a netlist, to perform automatic placement of said cells to be placed;
wherein said obtained cell library data include layout coordinates of diffusion layers within said cells to be placed, and
wherein said layout tool determines positions of said cells to be placed, referring to said layout coordinates of said diffusion layers.

2. The automatic layout apparatus according to claim 1, wherein said layout tool determines said positions of said cells to be placed based on a difference between diffusion layers within cells adjacent in a gate length direction of MOS transistors within said cells adjacent.

3. The automatic layout apparatus according to claim 2, wherein said layout tool determines said positions of said cells to be placed based on areas of said diffusion layers within said cells adjacent, in addition to said difference between diffusion layers within cells adjacent.

4. The automatic layout apparatus according to claim 1, wherein said obtained cell library data include layout coordinates of gates within said cells to be placed, and
said layout tool determines said positions of said cells to be placed based on said layout coordinates of said gates within said cells to be placed.

5. The automatic layout apparatus according to claim 1, further comprising a cell library generator generating said library data within said cell library by using other cell library data which do not include layout coordinates of diffusion layers for cells described therein, and layout data of said diffusion layers of said cells described in said other cell library data.

6. The automatic layout apparatus according to claim 5, wherein said other cell library data do not include layout coordinates of gates for cells described therein,
wherein said cell library generator generates said library data by using layout data of said gates of said cells described in said other cell library data.

7. The automatic layout apparatus according to claim 1, wherein said layout tool determines positions of first and second cells adjacent in a gate length direction so that a stress exerted to a MOS transistor within said first cell is equal to a stress exerted to a MOS transistor within said second cell.

8. A layout method comprising:
obtaining from a cell library cell library data associated with cells to be placed as described in a netlist, to perform automatic placement of said cells to be placed, said obtained cell library data including layout coordinates of diffusion layers within said cells to be placed; and
determining positions of said cells to be placed, referring to said layout coordinates of said diffusion layers.

9. A cell library generator apparatus comprising;
a storage unit for storing: original cell library data which do not include coordinate data of diffusion layers and gates within cells; and layout data of diffusion layers and gates within cells; and
a cell library generator generating modified cell library data from said original cell library data, said cell library generator obtaining said layout data of said diffusion layers and gates within said cells described in said original cell library data to incorporate said obtained layout data into said modified cell library data.
